(19) United States
(12) Patent Application Publication
(10) Pub. No.: US 2018/0069677 A1
(43) Pub. Date: Mar. 8, 2018

(54) PRE-ASSOCIATION MULTI-USER ACKNOWLEDGEMENT

(71) Applicant: QUALCOMM Incorporated, San Diego, CA (US)

(72) Inventors: George CHERIAN, San Diego, CA (US); Alfred ASTERJADHI, San Diego, CA (US); Raja BANERJEA, San Jose, CA (US); Abhishek Pramod PATIL, San Diego, CA (US)

(21) Appl. No.: 15/671,880

(22) Filed: Aug. 8, 2017

Related U.S. Application Data
(60) Provisional application No. 62/383,116, filed on Sep. 2, 2016.

(51) Int. Cl. H04L 5/00; H04W 72/00; H04W 74/08

(52) U.S. Cl. CPC H04L 5/0055; H04L 5/0007; H04W 88/02; H04W 74/0833; H04W 72/005

(57) ABSTRACT

Certain aspects of the present disclosure relate to communicating acknowledgements to multiple un-associated stations simultaneously. Certain aspects of the present disclosure provide a method for wireless communications by an access point (AP). The method includes receiving a first message from a first station (STA) that is not associated with the AP. The method further includes receiving a second message from a second STA that is not associated with the AP. The method further includes generating an aggregated acknowledgement message. The aggregated acknowledgement message includes a first acknowledgement (ACK) for the first message and a second ACK for the second message. The method further includes broadcasting the aggregated acknowledgement message for reception by the first STA and the second STA.

### CROSS-REFERENCE TO RELATED APPLICATIONS

This application claims the benefit of U.S. Provisional Patent No. 62/383,116, filed Sep. 2, 2016. The content of the provisional application is hereby incorporated by reference in its entirety.

### BACKGROUND

### Field of the Disclosure

Certain aspects of the present disclosure generally relate to wireless communications and, more particularly, to techniques for communicating acknowledgements to multiple un-associated stations simultaneously.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a method for wireless communications by an access point (AP). The method includes receiving a first message from a first station (STA) that is not associated with the AP. The method further includes receiving a second message from a second STA that is not associated with the AP. The method further includes generating an aggregated acknowledgement message. The aggregated acknowledgement message includes a first acknowledgement (ACK) for the first message and a second ACK for the second message. The method further includes broadcasting the aggregated acknowledgement message for reception by the first STA and the second STA.

Certain aspects of the present disclosure provide a method for wireless communications by a station (STA). The method includes transmitting a first message to an access point. The method further includes receiving an acknowledgement message. The message includes an acknowledgement (ACK) for the first message and an ACK for a second message associated with a second STA.

Certain aspects of the present disclosure provide an access point (AP). The AP includes a memory and a processor coupled to the memory. The processor is configured to receive a first message from a first station (STA) that is not associated with the AP. The processor is further configured to receive a second message from a second STA that is not associated with the AP. The processor is further configured to generate an aggregated acknowledgement message. The aggregated acknowledgement message includes a first acknowledgement (ACK) for the first message and a second ACK for the second message. The processor is further configured to broadcast the aggregated acknowledgement message for reception by the first STA and the second STA.

Certain aspects of the present disclosure provide a station (STA). The STA includes a memory and a processor coupled to the memory. The processor is configured to transmit a first message to an access point. The processor is further configured to receive an acknowledgement message. The message includes an acknowledgement (ACK) for the first message and an ACK for a second message associated with a second STA.

Certain aspects of the present disclosure provide an access point (AP). The AP includes means for receiving a first message from a first station (STA) that is not associated with the AP. The AP further includes means for receiving a second message from a second STA that is not associated with the AP. The AP further includes means for generating an acknowledgement message. The aggregated acknowledgement message includes a first acknowledgement (ACK) for the first message and a second ACK for the second message. The AP further includes means for broadcasting the aggregated acknowledgement message for reception by the first STA and the second STA.

Certain aspects of the present disclosure provide a station (STA). The STA includes means for transmitting a first message to an access point. The STA further includes means for receiving an acknowledgement message. The message includes an acknowledgement (ACK) for the first message and an ACK for a second message associated with a second STA.

Certain aspects of the present disclosure provide a computer readable medium having instructions stored thereon for causing at least one processor to perform a method. The method includes receiving a first message from a first station (STA) that is not associated with the AP. The method further includes receiving a second message from a second STA that is not associated with the AP. The method further includes generating an aggregated acknowledgement message. The aggregated acknowledgement message includes a first acknowledgement (ACK) for the first message and a second ACK for the second message. The method further includes broadcasting the aggregated acknowledgement message for reception by the first STA and the second STA.

Certain aspects of the present disclosure provide a computer readable medium having instructions stored thereon for causing at least one processor to perform a method. The method includes transmitting a first message to an access point. The method further includes receiving an acknowledgement message. The message includes an acknowledgement (ACK) for the first message and an ACK for a second message associated with a second STA.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example of a trigger frame in accordance with certain aspects.

FIG. 5 illustrates an example of a high efficiency (HE) physical layer convergence protocol (PLCP) protocol data unit (PPDU) in accordance with certain aspects.

FIG. 6 illustrates an example of a message including multiple acknowledgments for multiple stations in accordance with certain aspects.

FIG. 7 illustrates an example signal flow diagram for communications between an access point and a station in accordance with certain aspects.

FIG. 8 illustrates example operations that an access point may perform to communicate with a station before association of the station with the access point, according to aspects of the present disclosure.

FIG. 9 illustrates example operations that a station may perform to communicate with an access point before association with the access point, according to aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Certain aspects of the present disclosure are described with respect to the IEEE 802.11ax wireless communication standard, and utilizing terminology associated with IEEE 802.11ax. However, it should be noted that the techniques and aspects described herein may also be used with other suitable wireless communication standards.

Aspects of the present disclosure generally relate to communicating acknowledgements (ACKs) to multiple un-associated stations (STAs) simultaneously. In certain aspects, an access point (AP) may aggregate multiple ACKs or block ACKs (BAs) to multiple different STAs in a single message and broadcast that message to the multiple STAs. As defined in IEEE 802.11, an individual ACK is a single frame used to acknowledge reception of another single frame. A block ACK is a single frame that is used to acknowledge reception of multiple frames. In certain aspects, a block ACK includes a bitmap (e.g., of size 64*16 bits), each bit of the bitmap representing success/or failure of reception of a different frame.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

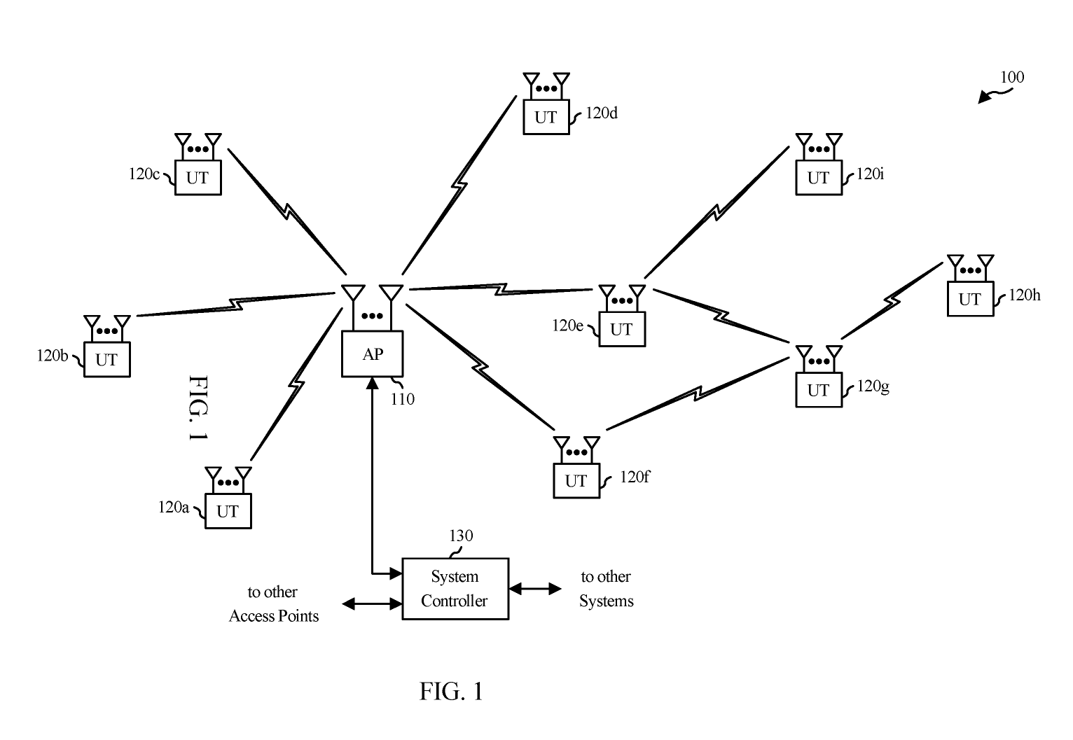

FIG. 1 illustrates a system 100 in which aspects of the disclosure may be performed. For example, multiple user terminals 120 may perform random access communication with an access point 110 prior to association with the access point 110. Further, the access point 110 may generate a message including ACKs for each of the multiple user terminals 120, and broadcast the message to the user terminals 120.

The system 100 may be, for example, a multiple-access multiple-input multiple-output (MIMO) system 100 with access points and user terminals. The system 100 may further support multi user (MU)-MIMO and MU-OFDMA communications. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

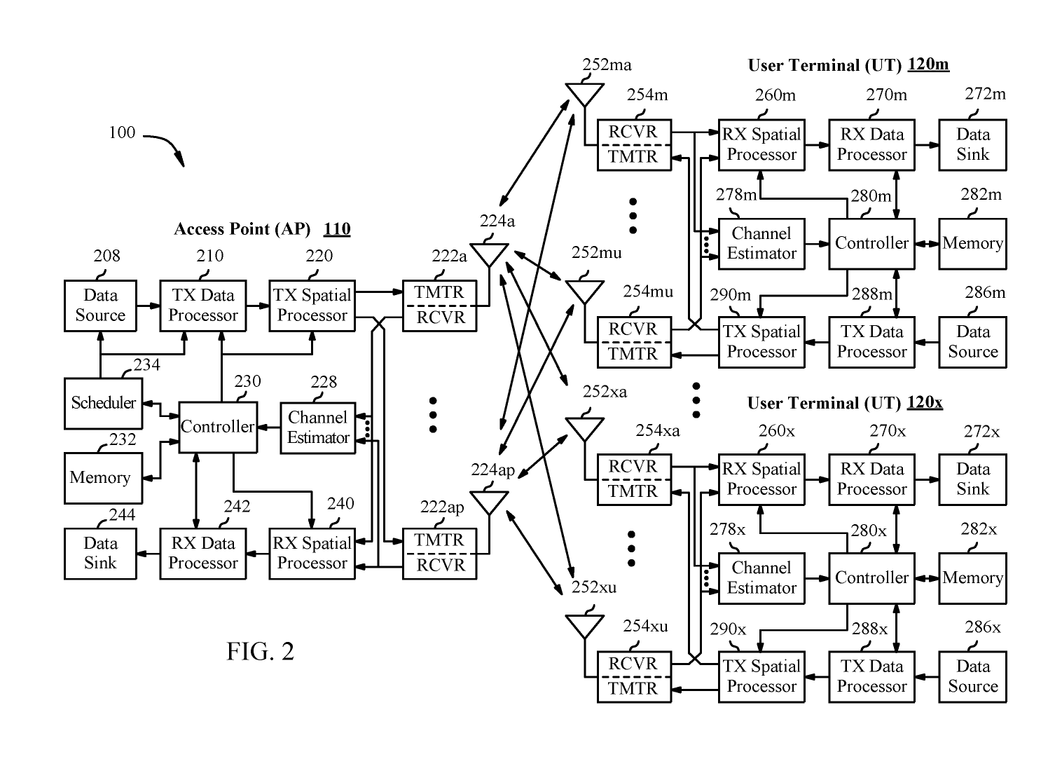

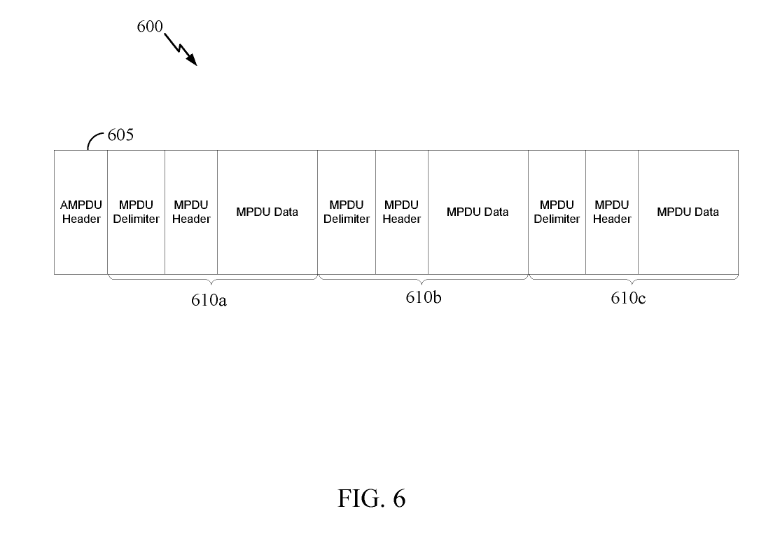

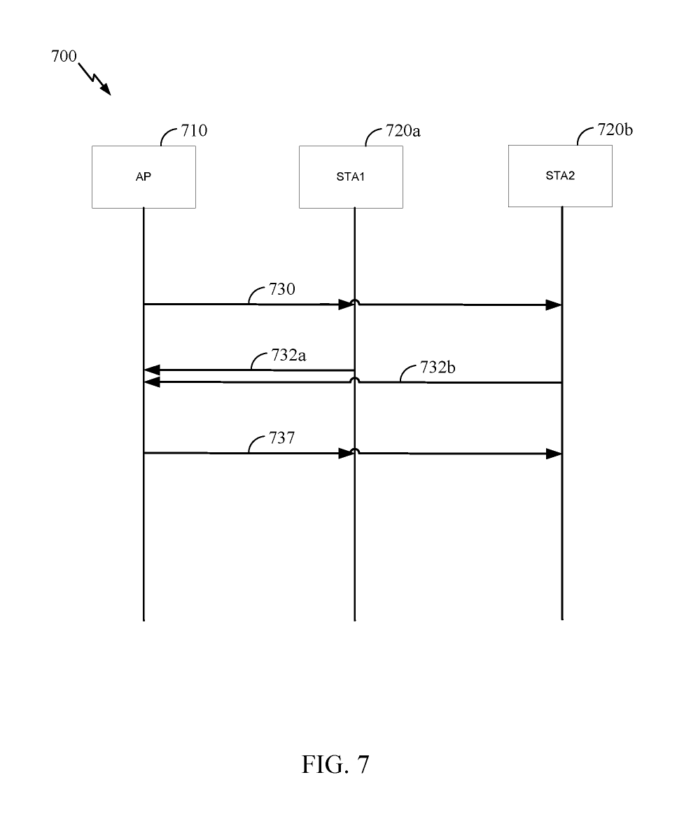

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 252, Tx/Rx 254, processors 260, 270, 288, and 290, and/or controller 280 may be used to perform the operations described herein and illustrated with reference to FIG. 7. For example, antenna 224, Tx/Rx 222, processors 210, 220, 240, and 242, and/or controller 230 may be used to perform the operations described herein and illustrated with reference to FIG. 6.

FIG. 2 illustrates a block diagram of access point 110 and two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

In some aspects, the Nᵤₚ user terminals may not be scheduled for transmission on the uplink, and instead the access point 110 may allow random access to resources (e.g., time resources, frequency resources, and/or spatial dimensions, such as symbols, tones, spatial streams, resource units, etc.) on the uplink to communicate with the access point 110 by broadcasting a trigger frame identifying the resources to the Nᵤₚ user terminals. For example, the Nᵤₚ user terminals may use random backoff mechanisms where the user terminals first check if a resource is available before utilizing the resources to avoid collisions. The Nᵤₚ user terminals may use the random access to resources on the uplink to communicate with the access point prior to association with the access point.

At access point 110, Nₐₚ antennas 224a through 224ap receive the uplink signals from all Nᵤₚ user terminals transmitting on the uplink. For example, the access point 110 may receive data from the Nᵤₚ user terminals using random access procedures on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

In some aspects, the access point 110, instead of scheduling transmissions to the N_{dn} user terminals on the downlink, may broadcast a message to the N_{dn} user terminals based on data received from the user terminals using random access procedures on the uplink. For example, the access point 110 may generate a single broadcast message that includes acknowledgements for a plurality of N_{dn} user terminals and broadcast the message on the downlink to the multiple N_{dn} user terminals.

At each user terminal 120, N_{ut,m} antennas 252 receive the Nₐₚ downlink signals from access point 110. For example, each user terminal 120 may receive the broadcast message from the access point 110 with acknowledgements for multiple user terminals and process the acknowledgement for the given user terminal 120. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

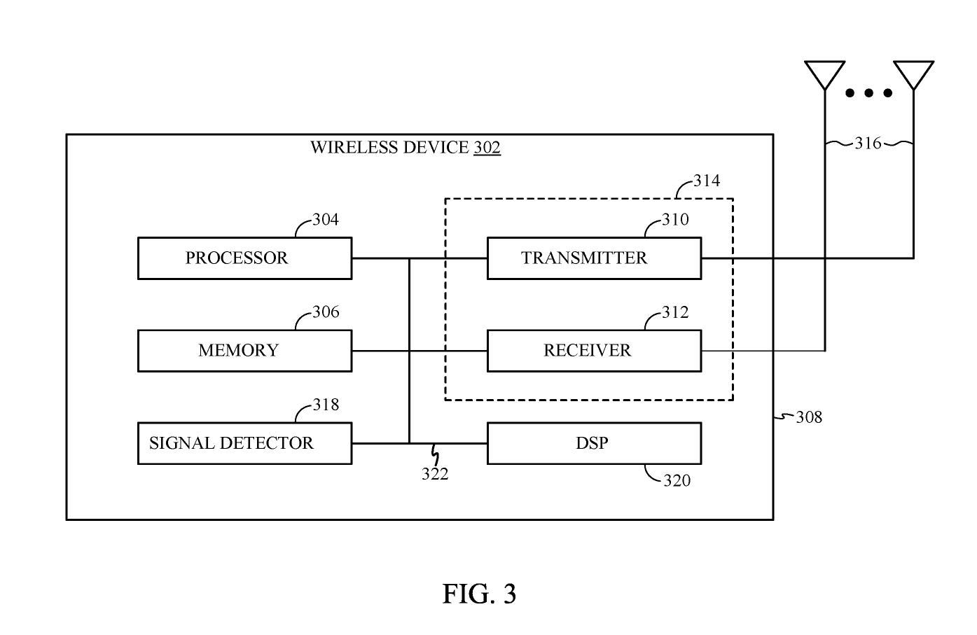

FIG. 3 illustrates various components that may be utilized in a wireless device 302 that may be employed within the MIMO system 100. The wireless device 302 is an example of a device that may be configured to implement the various methods described herein. For example, the wireless device may implement operations 600 and 700 illustrated in FIGS. 6 and 7, respectively. The wireless device 302 may be an access point 110 or a user terminal 120. For example, the wireless device 302 may be a user terminal configured to use random access procedures to send data to an access point 110 before associating with the access point 110. In another example, the wireless device 302 may be an access point 110 configured to generate and broadcast a single message to a plurality of user terminals 120 not associated with the access point 110 including acknowledgements for the plurality of user terminals 120 based on data received from the plurality of user terminals 120 using random access procedures.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein. For example, the processor 304 may perform random access procedures, generate messages with multiple acknowledgements, process acknowledgements, etc.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers. For example, the transceiver 314 may send data using random access procedures, receive data, send broadcast messages with a plurality of acknowledgement, receive broadcast messages with a plurality of acknowledgements, etc.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example for Aggregating Multiple ACKs for Multiple STAs in a Single Message

Random access using uplink (UL) OFDMA is defined in the 802.11ax wireless communication standard. In particular, random access allows STAs to randomly access uplink transmission resources (e.g., resource units (RUs), spatial streams, time resources, frequency resources, etc.) to communicate with an AP. In particular, an STA can wirelessly transmit data to an AP on an uplink. In order for multiple STAs to transmit data to the AP, the STAs can communicate at different times, in different frequency bands, and/or by using beamforming so that transmissions from different STAs are spatially separate, so as not to interfere with one another. For example, the uplink may correspond to one or more frequency bands (e.g., referred to as channels) having a specified bandwidth, meaning the STA can transmit data to the AP over the one or more frequency bands. These one or more frequency bands may further be divided into one or more subsets of frequency bands, referred to as subchannels or RUs. The different frequency bands and subsets of frequency bands may be used by different STAs to transmit data to the AP. If different STAs utilize different frequency bands for transmitting data to the AP, the transmissions do not interfere and the AP can distinguish between transmissions based on the frequency bands on which they are received. Accordingly, the different frequency bands and subsets of frequency bands may be different frequency resources of the uplink that STAs can use to transmit data to the AP.

Similarly, transmission on the uplink may happen at different time periods (e.g., referred to as symbols). In particular, timing of the uplink may be divided into a number of time periods. If multiple STAs transmit data on the uplink to the AP at different time periods, even if using the same frequency bands, then the transmissions will not interfere with one another and the AP can distinguish between transmissions based on the time period at which they are received. Accordingly, the different time periods may be different time resources of the uplink that STAs can use to transmit data to the AP.

In another example, STAs may have multiple transmit antennas each coupled to a separate transmit chain and the AP may have multiple receive antennas each coupled to a separate receive chain. Therefore, there are multiple paths that radio transmissions can take from a STA to the AP (i.e., a different path between each pair of transmit antennas and receive antennas). These different paths may be referred to as spatial streams. These different paths can each carry different or unique data transmissions.

For example, the STAs may use random backoff mechanisms where the STA first checks if an uplink transmission resource is available before utilizing the uplink transmission resource to transmit data to the AP avoid collisions. If the uplink transmission resource is available, the STA may utilize the uplink transmission resource to transmit data to the AP. If not, the STA may backoff for a period of time (e.g., based on a timer) and then try again to utilize the uplink transmission resource to transmit data to the AP.

Further, in certain aspects, STAs may communicate with an AP, before association with the AP. For example, normally an STA performs an association procedure with an AP and is assigned an identifier (e.g., AID), so that communications between the STA and the AP can be differentiated from communications between other STAs and the AP. The AP may further schedule communications for the associated STAs using scheduling mechanisms. However, STAs that are not associated with an AP (e.g., in a pre-association status with the AP) cannot be scheduled for UL or downlink (DL) transmissions (e.g., OFDMA transmissions) and do not have an assigned identifier.

Accordingly, in certain aspects, random access procedures are used for communication between an AP and any STAs not associated with the AP. Such random access procedures may be sufficient for communications between the AP and pre-association STAs, since there may not be a significant amount of data communicated between the AP and the pre-association STAs.

In certain aspects, since the STAs utilize random access procedures for pre-association signaling and communication, multiple STAs can send data at the same time in a UL OFDMA transmission to the AP (e.g., on different uplink transmission resources, e.g., RUs, of the OFDM transmission). However, an AP may need to acknowledge (send an ACK or block ACK (BA)) to each of the STAs based on the messages received from the multiple STAs. Since the STAs are not associated with the AP, the AP may not be able to use standard single user communications to send an ACK to each of the multiple STAs. In a standard single user communication, the communication may be directed to a single STA by including an identifier of the STA in the communication.

Accordingly, aspects of the present disclosure generally relate to communicating acknowledgements to multiple un-associated STAs simultaneously. For example, an AP 110 may broadcast a message on a DL to multiple STAs 120 to enable any of the STAs 120 to use random access uplink transmission resources to communicate with the AP 110. The AP 110 may broadcast the message in a downlink transmission resource (e.g., RU corresponding to a specific frequency band) dedicated for broadcast messages. All STAs 120 may be configured to receive communications on the downlink transmission resource. In another embodiment, the AP 110 may broadcast the message as a single user (SU) transmission, meaning the AP 110 transmits the message across all frequency resources (e.g., all RUs) of the DL. The message may indicate the uplink transmission resources (e.g., frequency, time, etc.) that the STAs 120 can utilize to communicate with the AP 110. The STAs 120 may not have an association with the AP 110 (e.g., may not be assigned an AID), but can still utilize the random access uplink transmission resources (e.g., based on random backoff procedures) to communicate with the AP 110.

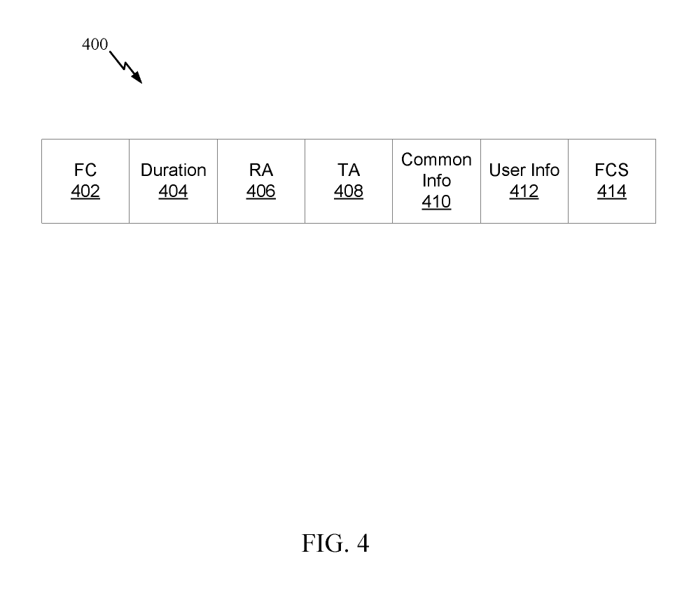

For example, the AP 110 may broadcast a trigger frame on a DL enabling random access for multi-user (MU) UL Orthogonal Frequency Division Multiple Access (OFDMA) transmissions. FIG. 4 illustrates an example of a trigger frame 400 in accordance with certain aspects. The trigger frame 400 includes a frame control (FC) field 402, which includes information regarding a frame type (i.e., trigger frame) of the trigger frame 400. The trigger frame 400 further includes a duration field 404 including a duration value defined for the frame type indicating the duration of the trigger frame 400. The trigger frame 400 further includes a receiver address (RA) field 406, which includes information regarding an intended recipient of the trigger frame 400. Since the trigger frame 400 is a broadcast frame for all STAs, the RA field 406 may include a broadcast address designated for broadcasts. The trigger frame 400 further includes a transmitter address (TA) field 408, which includes an address of the AP 110 broadcasting the trigger frame 400. The trigger frame 400 further includes a common info field 410, which includes information common to all STAs receiving the trigger frame 400 such as transmit power of the trigger frame 400. The trigger frame 400 further includes a user information field 412, which may indicate an intended recipient of the trigger frame 400. Since the trigger frame 400 is a broadcast frame, the user information field 412 may include a broadcast identifier (e.g., broadcast station identifier (STAID)) that is not actually associated with a particular STA 120, but rather associated with any STAs 120 utilizing the random access resources (e.g., spatial streams or RUs) to communicate with the AP 110. In certain aspects, the broadcast station identifier is expressed using a BA bitmap space of a multi-STA BA frame. In some aspects, the trigger frame does not explicitly include a broadcast station identifier, and instead the trigger frame is implicitly determined to be a trigger frame as described based on the plurality of uplink transmission resources identified in the trigger frame. The user information field 412 may further indicate a number uplink transmission resources such as spatial streams (e.g., for MU-multiple-input-multiple output (MU-MIMO) transmissions) and/or one or more resource units (RUs) (e.g., sizes and frequencies of RUs) (e.g., for OFDMA transmissions) that can be randomly accessed by multiple STAs 120 on an UL. The AP 110 may broadcast the trigger frame on a RU designated for broadcast (e.g., a broadcast RU), a multi-cast RU, or as a SU transmission as discussed. In certain aspects, specific uplink transmission resources may be associated or assigned to particular STAs or groups of STAs. Accordingly, depending on the uplink transmission resources indicated in the trigger frame 400, a STA implicitly can determine if the trigger frame 400 is intended for the STA. For example, if the uplink transmission resources indicated in the trigger frame 400 are assigned to an STA, the STA determines the trigger frame 400 is intended for the STA. If the uplink transmission resources indicated in the trigger frame 400 is not assigned to an STA, the STA determines the trigger frame 400 is not intended for the STA. The trigger frame 400 may further include a frame check sequence (FCS) field 414, which includes a FCS that may be an error-detecting code to be used to check for errors in the received trigger frame 400 at a STA.

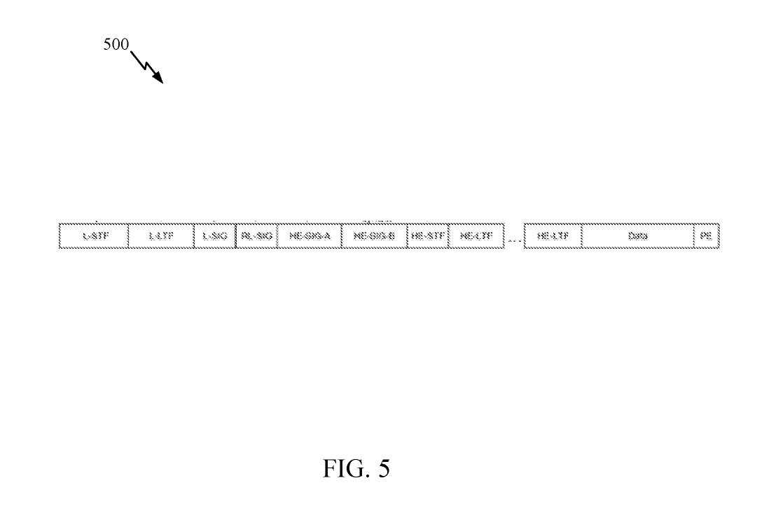

In certain aspects, multiple STAs 120 may utilize the random access resources on the UL to transmit data in one or more messages to the AP 110. In certain aspects, for OFDMA transmissions, the AP 110 may receive transmissions from multiple STAs 120 on the random access RUs on the UL. For example, the STAs 120 may transmit data to the AP 110 on the UL in a high efficiency (HE) physical layer convergence protocol (PLCP) protocol data unit (PPDU) based on receiving the trigger frame from the AP 110 on the DL. FIG. 5 illustrates an example of a HE PPDU 500 in accordance with certain aspects. As shown, the HE-PPDU 500 includes a legacy short training field (L-STF), legacy long training field (L-LTF), a legacy signaling field (L-SIG), a repeated legacy signaling field (RL-SIG), a first high efficiency signaling field (HE-SIG-A), a second high efficiency signaling field (HE-SIG-B), a high efficiency short training field (HE-STF), one or more high efficiency long training fields (HE-LTF), a data field, and a packet extension (PE) field. The content of the fields may include content defined by the IEEE 802.11ax standard.

Each STA 120 may select the acknowledgement (ACK) policy for the STA 120 and indicate the selected ACK policy in the message (e.g., HE PPDU) sent to the AP 110. For example, the indication of the selected ACK policy may be included in the data field of a HE PPDU. Multiple STAs 120 may request an ACK (e.g., single ACK (e.g., a single bit) or multiple ACKs for multiple messages (e.g., HE PPDUs) in a block ACK (BA) (e.g., multiple bits, such as a bitmap)) be transmitted at the same time by the AP 110. For example, each STA 120 may select an immediate ACK policy, where the STA 120 requests the AP 110 send an immediate ACK based on the AP 110 receiving the HE PPDU(s) from the STA 120, the ACK acknowledging that the AP 110 received the HE PPDU(s).

In certain aspects, the AP 110 may accordingly aggregate multiple ACKs to multiple different STAs 120 in a single message (e.g., referred to as an aggregated acknowledgment message) and broadcast that message to the multiple STAs 120. For example, the AP 110 may generate an aggregated media access control (MAC) protocol data unit (AMPDU) that aggregates or groups together a plurality of MAC protocol data units (MPDUs). In certain aspects, the AMPDU conforms to a DL MU-OFDMA format. In certain aspects, each MPDU of the AMPDU may include an ACK or BA for a single STA 120. In certain aspects, the MPDU for a given STA 120 includes a receiver address (RA) field set to the address of the given STA 120.

FIG. 6 illustrates an example of an AMPDU 600 in accordance with certain aspects. As shown, the AMPDU includes multiple MPDUs 610a, 610b, and 610c. Each MPDU 610 includes a MPDU delimiter to separate between the MPDUs, a MPDU header (e.g., a MAC header), and a MPDU data field. As discussed, each MPDU 610 may be associated with a different STA 120. For example, each MPDU 610 in the MPDU data field may include an ACK (e.g., single bit) or BA (e.g., multiple bits). Further, each MPDU 610 may include in the MPDU header a RA field set to the address of the associated STA 120. The AMPDU 600 may further include a single physical layer (PHY) header 605 referred to as an AMPDU header for the plurality of MPDUs 610. In certain aspects, the header 605 includes a preamble (e.g., a HE-SIG-A preamble, or a HE-SIG-B preamble). The preamble of the AMPDU 600 may include the broadcast identifier (e.g., STAID with a particular value indicating it is for broadcast) from the trigger frame (e.g., trigger frame 400). In certain aspects, the preamble may also indicate one or more of the number of MPDUs 610 in the AMPDU 600, the number of ACKs in the AMPDU 600, and a service set identifier (SSID) of the AP 110. In some aspects, any AMPDU 600 transmitted in response to receiving UL data from STAs in random access mode may be defined as including ACKs for multiple STAs 120. In some aspects, the AMPDU 600 may include an indicator that explicitly indicates that the AMPDU 600 includes multiple ACKs for multiple different STAs 120. For example, a frame check sequence (FCS) of the AMPDU 600 may indicate that the AMPDU 600 is for multiple STAs 120. In certain aspects, an offset may be applied to the FCS, the offset indicating that the AMPDU 600 is for multiple STAs 120.

The AP 110 may broadcast the AMPDU 600 (e.g., in a broadcast RU, in a similar manner as SU transmission, etc.) to the STAs 120. The STAs 120 may receive the broadcast AMPDU 600 and receive the ACK or BA for each STA 120 in the MPDU 610 with an RA corresponding to the STA 120. For example, the STA 120 may determine the AMPDU 600 indicates multiple ACKs for multiple STAs 120 (e.g., based on the RU over which the AMPDU 600 is received, based on an FCS of the AMPDU 600, etc.), and then determine which MPDU 610 is for the STA 120 (e.g., based on the RA in the MPDU 610 matching an address associated with the STA 120). In some aspects, the RA for an STA 120 may be implicitly derived (e.g., by the STA 120 and/or AP 110) based on the random access resource(s) used by the STA 120 on the UL. The STA 120 may then process the MPDU 610 and the ACK or BA in the MPDU 610 for the STA 120.

FIG. 7 illustrates an example signal flow diagram for communications between an AP 710 and STAs 720a and 720b. For example, AP 710 may correspond to an AP similar to AP 110. Further, each of STAs 720a and 720b may correspond to STAs similar to STAs 120.

At 730, the AP 710 generates a message (e.g., trigger frame) and broadcasts the message on a DL to the STAs 720a and 720b. In certain aspects, the trigger frame includes RUs allocated for random access on an UL for UL OFDMA transmissions. In certain aspects, the AP 710 broadcasts the trigger frame on an RU dedicated for broadcasts. In certain aspects, the trigger frame includes a STAID allocated for broadcasts.

At 732a, the STA 720a transmits data in a message (e.g., HE PPDU) to the AP 710 on RUs indicated in the trigger frame from the AP 710. In certain aspects, the message includes an ACK policy for the message. At approximately the same time, the STA 720b transmits data in a message (e.g., HE PPDU) to the AP 710 on RUs indicated in the trigger frame from the AP 710. In certain aspects, the message includes an ACK policy for the message.

The AP 710 receives the messages from the STAs 720a and 720b and, at 737, generates a message (e.g., AMPDU) including ACKs (or BAs) for each of the STAs 720a and 720b and broadcasts the message to the STAs 720a and 720b. STAs 720a and 720b may receive the broadcast message and process their respective ACKs in the broadcast message.

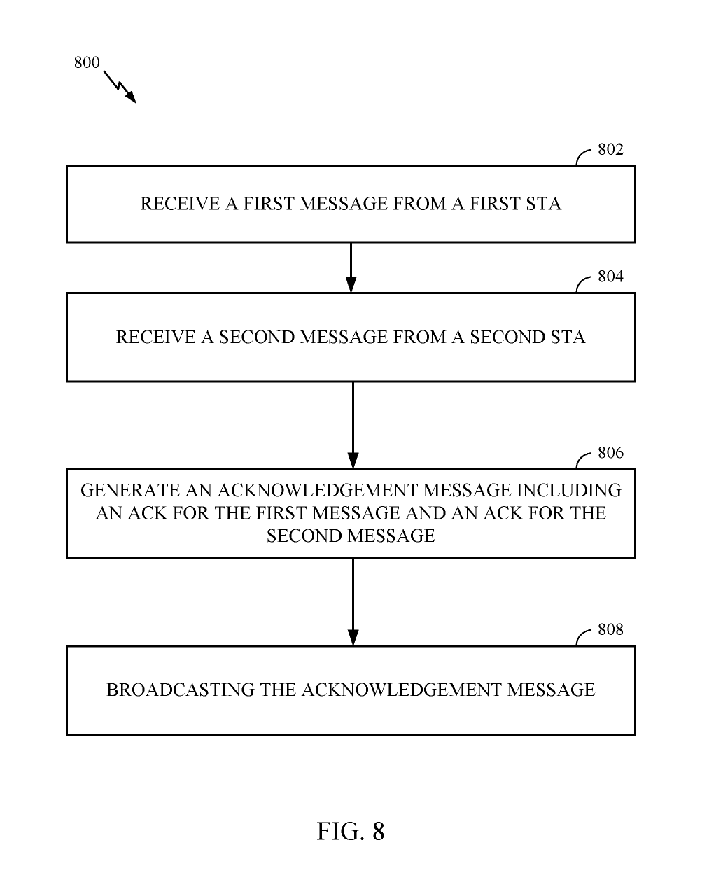

FIG. 8 illustrates example operations 800 that an AP (e.g., AP 110 shown in FIG. 1, AP 710 shown in FIG. 7) may perform to communicate with a STA before association with the AP, according to aspects of the present disclosure.

At 802, the AP receives a first message from a first STA. For example, the first message may be a HE PPDU received in response to a trigger frame transmitted by the AP. The first message may be received on a RU indicated in the trigger frame.

At 804, the AP receives a second message from a second STA. For example, the second message may be a HE PPDU received in response to a trigger frame transmitted by the AP. The second message may be received on a RU indicated in the trigger frame.

At 806, the AP generates an acknowledgement message including an ACK for the first message and an ACK for the second message. For example, the AP may generate an AMPDU with a first MPDU including an ACK for the first message, and a second MPDU including an ACK for the second message.

At 808, the AP broadcasts the acknowledgement message for reception by the first STA and the second STA. For example, the AP may broadcast the acknowledgement message as a SU transmission. In another example, the AP may broadcast the acknowledgement message on a broadcast RU. In another example, the AP may broadcast the acknowledgement message on a multi-cast RU.

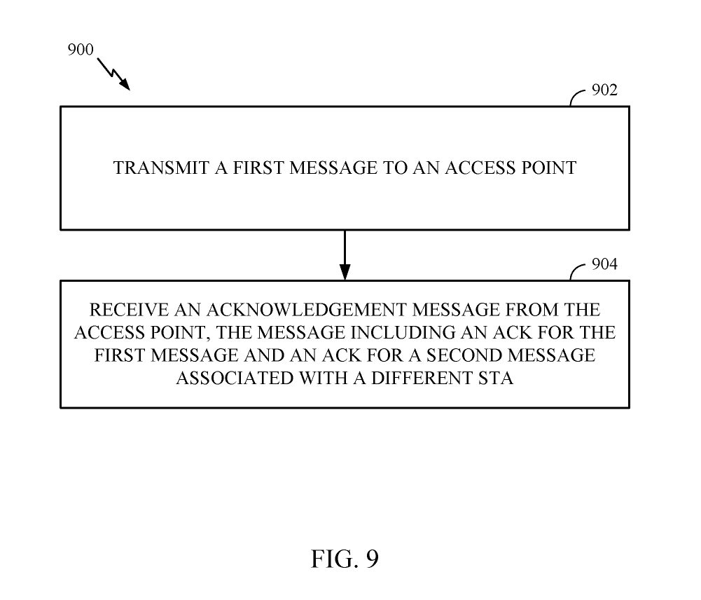

FIG. 9 illustrates example operations 900 that a STA (e.g., STA 120 shown in FIG. 1, STA 520 shown in FIG. 5) may perform to communicate with an AP before association with the AP, according to aspects of the present disclosure.

At 902, the STA transmits a first message to the AP. For example, the first message may be a HE PPDU transmitted in response to a trigger frame received from the AP. The first message may be transmitted on a RU indicated in the trigger frame.

At 904, the STA receives an acknowledgement message including an ACK for the first message and an ACK for a second message associated with a second STA. For example, the acknowledgement message may be an AMPDU with a first MPDU including an ACK for the first message, and a second MPDU including an ACK for the second message. The STA may receive the acknowledgement message as a SU transmission. In another example, the STA may receive the acknowledgement message on a broadcast RU. In another example, the STA may receive the acknowledgement message on a multi-cast RU.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

For example, means for receiving may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for determining, means for outputting, and means for performing (e.g., a CCA) may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described herein.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by an access point (AP), comprising:
receiving a first message from a first station (STA) that is not associated with the AP;
receiving a second message from a second STA that is not associated with the AP;
generating an aggregated acknowledgement message, the aggregated acknowledgement message comprising a first acknowledgement (ACK) for the first message and a second ACK for the second message; and
broadcasting the aggregated acknowledgement message for reception by the first STA and the second STA.

2. The method of claim 1, further comprising transmitting a broadcast message, the broadcast message indicating a plurality of uplink transmission resources available for random access by a plurality of STAs to transmit to the AP, wherein the first STA and the second STA are part of the plurality of STAs, wherein the first message and the second message are each received on at least one of the plurality of uplink transmission resources indicated in the broadcast message.

3. The method of claim 2, wherein the plurality of uplink transmission resources comprise at least one of time resources, frequency resources, or spatial streams available for transmitting on an uplink from the plurality of STAs to the AP.

4. The method of claim 2, wherein the broadcast message comprises a trigger frame indicating the plurality of transmission resources, the plurality of transmission resources comprising resource units of an orthogonal frequency divisional multiple access (OFDMA) transmission of an uplink from the plurality of STAs to the AP.

5. The method of claim 2, wherein the broadcast message comprises an identifier of STAs including the first STA and the second STA allowed to utilize the plurality of uplink transmission resources to transmit to the AP.

6. The method of claim 2, wherein each of the plurality of uplink transmission resources are assigned to one or more STAs including the first STA and the second STA.

7. The method of claim 1, wherein each of the first message and the second message comprises a high efficiency (HE) physical layer convergence protocol (PLCP) protocol data unit (PPDU).

8. The method of claim 1, wherein at least one of the first ACK or the second ACK comprises a block ACK.

9. The method of claim 1, wherein the aggregated acknowledgement message comprises an aggregated media access control (MAC) protocol data unit (AMPDU) comprising a plurality of MAC protocol data units (MPDUs).

10. The method of claim 9, wherein the AMPDU comprises a first MPDU comprising the first ACK and a second MPDU comprising the second ACK.

11. The method of claim 10, wherein the first MPDU includes a first receiver address field comprising a first address of the first STA and the second MPDU includes a second receiver address field comprising a second address of the second STA.

12. The method of claim 1, wherein the aggregated acknowledgement message comprises an indicator indicating the aggregated acknowledgement message includes multiple ACKs for multiple STAs including the first ACK for the first STA and the second ACK for the second STA.

13. The method of claim 12, wherein the indicator comprises a frame check sequence with an offset.

14. The method of claim 1, wherein the aggregated acknowledgement message is broadcast by the AP across an entire frequency bandwidth of a downlink between the AP and a plurality of STAs including the first STA and the second STA and includes a station identifier (STAID) indicating the aggregated acknowledgment message is a broadcast type message.

15. The method of claim 1, wherein the aggregated acknowledgement message is broadcast on a portion of a frequency bandwidth of a downlink between the AP and a plurality of STAs including the first STA and the second STA reserved for broadcasts.

16. An access point (AP) comprising:
a memory; and
a processor coupled to the memory, the processor being configured to:
receive a first message from a first station (STA) that is not associated with the AP;
receive a second message from a second STA that is not associated with the AP;
generate an aggregated acknowledgement message, the aggregated acknowledgement message comprising a first acknowledgement (ACK) for the first message and a second ACK for the second message; and
broadcast the aggregated acknowledgement message for reception by the first STA and the second STA.

17. The AP of claim 16, wherein the processor is further configured to transmit a broadcast message, the broadcast message indicating a plurality of uplink transmission resources available for random access by a plurality of STAs to transmit to the AP, wherein the first STA and the second STA are part of the plurality of STAs, wherein the first message and the second message are each received on at least one of the plurality of uplink transmission resources indicated in the broadcast message.

18. The AP of claim 17, wherein the broadcast message comprises a trigger frame indicating the plurality of transmission resources, the plurality of transmission resources comprising resource units of an orthogonal frequency divisional multiple access (OFDMA) transmission of an uplink from the plurality of STAs to the AP.

19. The AP of claim 17, wherein the broadcast message comprises an identifier of STAs including the first STA and the second STA allowed to utilize the plurality of uplink transmission resources to transmit to the AP.

20. The AP of claim 16, wherein each of the first message and the second message comprises a high efficiency (HE) physical layer convergence protocol (PLCP) protocol data unit (PPDU).

21. The AP of claim 16, wherein at least one of the first ACK or the second ACK comprises a block ACK.

22. The AP of claim 16, wherein the aggregated acknowledgement message comprises an aggregated media access control (MAC) protocol data unit (AMPDU) comprising a plurality of MAC protocol data units (MPDUs).

23. The AP of claim 22, wherein the AMPDU comprises a first MPDU comprising the first ACK and a second MPDU comprising the second ACK.

24. The AP of claim 23, wherein the first MPDU includes a first receiver address field comprising a first address of the first STA and the second MPDU includes a second receiver address field comprising a second address of the second STA.

25. The AP of claim 16, wherein the aggregated acknowledgement message comprises an indicator indicating the aggregated acknowledgement message includes multiple ACKs for multiple STAs including the first ACK for the first STA and the second ACK for the second STA.

26. The AP of claim 25, wherein the indicator comprises a frame check sequence with an offset.

27. The AP of claim 16, wherein the aggregated acknowledgement message is broadcast by the AP across an entire frequency bandwidth of a downlink between the AP and a plurality of STAs including the first STA and the second STA and includes a station identifier (STAID) indicating the aggregated acknowledgment message is a broadcast type message.

28. The AP of claim 16, wherein the aggregated acknowledgement message is broadcast on a portion of a frequency bandwidth of a downlink between the AP and a plurality of STAs including the first STA and the second STA reserved for broadcasts.

29. An access point (AP) comprising:
means for receiving a first message from a first station (STA) that is not associated with the AP;
means for receiving a second message from a second STA that is not associated with the AP;
means for generating an aggregated acknowledgement message, the aggregated acknowledgement message comprising a first acknowledgement (ACK) for the first message and a second ACK for the second message; and
means for broadcasting the aggregated acknowledgement message for reception by the first STA and the second STA.

30. A computer readable medium having instructions stored thereon for causing at least one processor to perform a method, the method comprising:
receiving a first message from a first station (STA) that is not associated with the AP;
receiving a second message from a second STA that is not associated with the AP;
generating an aggregated acknowledgement message, the aggregated acknowledgement message comprising a first acknowledgement (ACK) for the first message and a second ACK for the second message; and
broadcasting the aggregated acknowledgement message for reception by the first STA and the second STA.
